(19) United States
(12) Patent Application Publication
(10) Pub. No.: US 2022/0215034 A1
(43) Pub. Date: Jul. 7, 2022

(54) ELECTRONIC APPARATUS AND CONTROLLING METHOD THEREOF

(71) Applicant: Samsung Electronics Co., Ltd., Suwon-si (KR)

(72) Inventors: Kangyong PARK, Suwon-si (KR); Seungho JUNG, Seoul (KR); Minhyeok KWEUN, Suwon-si (KR); Kyungjae KIM, Suwon-si (KR); Goeun KIM, Suwon-si (KR); Eunkyu OH, Suwon-si (KR); Hyun HEO, Suwon-si (KR); Jisoo HWANG, Suwon-si (KR)

(21) Appl. No.: 17/495,273

(22) Filed: Oct. 6, 2021

Related U.S. Application Data
(63) Continuation of application No. PCT/KR2021/008846, filed on Jul. 9, 2021.

(30) Foreign Application Priority Data
Jan. 5, 2021 (KR) 10-2021-0000864

(51) Int. Cl. G06F 16/25; G06N 5/02

(52) U.S. Cl. CPC G06F 16/258; G06N 5/022

(57) ABSTRACT

An electronic apparatus is provided. The electronic apparatus includes a storage and a processor to generate first training data by performing transformation for first original data based on at least one first transform function input according to a user input, store first metadata including the at least one first transform function in the storage, generate second training data by performing transformation for second original data based on at least one first transform function included in the stored first metadata, generate third training data by performing transformation for the second training data based on at least one second transform function input according to a user input, and store second metadata including the at least one first transform function and the at least one second transform function in the storage.

### CROSS-REFERENCE TO RELATED APPLICATION(S)

This application is a continuation application, claiming priority under § 365(c), of an International application No. PCT/KR2021/008846, filed on Jul. 9, 2021, which is based on and claims the benefit of a Korean patent application number 10-2021-0000864, filed on Jan. 5, 2021, in the Korean Intellectual Property Office, the disclosure of which is incorporated by reference herein in its entirety.

### BACKGROUND

### 1. Field

The disclosure relates to an electronic apparatus and a method for controlling thereof. More particularly, the disclosure relates to an electronic apparatus related to data preprocessing of a machine learning model and a method for controlling thereof.

### 2. Description of the Related Art

Data preprocessing in the field of machine learning refers to a process of transforming input data into a format suitable to a machine learning algorithm by applying various transform functions to the input data.

A machine learning model developer may preprocess original data in various ways to generate various versions of training data, and may improve the performance of the model by using the generated training data.

In detail, the developer may train a model by applying various versions of training data, and may identify that the performance of the model would be the best by using which model for the training. Accordingly, the developer may find a preprocessing method applied to the training data of a version which was applied to the best performance model, and may improve the performance of the model by transforming the input data using the preprocessing method for training the model afterwards.

In the related art, for data preprocessing, a developer needs to manually apply transform functions to original data. Thus, the developer has to repeat the same task every time even for the same type of data.

When a new version of training data is created by adding or modifying a transform function to the training data of the previous version, the developer needs to memorize the preprocessing method (i.e., the order or content of the transform functions that have been applied) that was applied to the previous version of the training data, apply the method again in the same manner and then add or modify the transform function, which is a cumbersome work to the developer.

When a result value is inferred using the trained model, the developer needs to memorize the transform functions applied to the training data that was used for training the corresponding model and manually applies the converted functions to the input data, and this is a very annoying task for a developer.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a more convenient environment for developing a machine learning model by storing metadata for a data preprocessing process and performing data preprocessing using the same.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a storage and a processor to generate first training data by performing transformation for first original data based on at least one first transform function input according to a user input, store first metadata including the at least one first transform function in the storage, generate second training data by performing transformation for second original data based on at least one first transform function included in the stored first metadata, generate third training data by performing transformation for the second training data based on at least one second transform function input according to a user input, and store second metadata including the at least one first transform function and the at least one second transform function in the storage.

The processor may store, in the storage, the first metadata including a plurality of first transform functions applied to the first original data and sequence information in which the plurality of first transform functions are applied, and perform transformation for the second original data by applying the plurality of first transform functions to the second original data based on the sequence information included in the stored first metadata.

The processor may store, in the storage, the second metadata including the plurality of first transform functions, the plurality of second transform functions applied to the second training data, sequence information in which the plurality of first and second transform functions are applied with reference to the second original data.

The first original data and second original data, respectively, may be data in a table format including a plurality of columns.

The processor may, based on a number and a name of a plurality of columns included in the first original data and the second original data being identical with each other, and formats of data included in the same column being identical with each other, perform transformation for the second original data based on at least one first transform function included in the stored first metadata.

Each of the first transform function and the second transform function may include at least one of a transform function to delete a specific row from the data in the table format, a transform function to fill a null value of a specific column, a transform function to extract a specific value from data of a specific column, a transform function to discard a value less than or equal to a decimal point from data of a specific column, or a transform function to align the data of a specific column.

The input data of a machine learning model trained based on the first training data may be generated based on the at least one first transform function included in the stored first metadata, and input data of a machine learning model trained based on the third training data may be generated based on the at least one first transform function and the at least one second transform function included in the stored second metadata.

In accordance with another aspect of the disclosure, a method for controlling an electronic apparatus is provided. The method includes generating first training data by performing transformation for first original data based on at least one first transform function input according to a user input, storing first metadata including the at least one first transform function in the storage, generating second training data by performing transformation for second original data based on at least one first transform function included in the stored first metadata, generating third training data by performing transformation for the second training data based on at least one second transform function input according to a user input, and storing second metadata including the at least one first transform function and the at least one second transform function in the storage.

The storing the first metadata in the storage may include storing, in the storage, the first metadata including a plurality of first transform functions applied to the first original data and sequence information in which the plurality of first transform functions are applied, and the generating the second training data may include performing transformation for the second original data by applying the plurality of first transform functions to the second original data based on the sequence information included in the stored first metadata.

The storing second metadata in the storage may include storing, in the storage, the second metadata including the plurality of first transform functions, the plurality of second transform functions applied to the second training data, sequence information in which the plurality of first and second transform functions are applied based on the second original data.

The first original data and second original data, respectively, may be data in a table format including a plurality of columns.

The generating the second training data may include, based on a number and a name of a plurality of columns included in the first original data and the second original data being identical with each other, and formats of data included in the same column being identical with each other, performing transformation for the second original data based on at least one first transform function included in the stored first metadata.

Each of the first transform function and the second transform function may include at least one of a transform function to delete a specific row from the data in the table format, a transform function to fill a null value of a specific column, a transform function to extract a specific value from data of a specific column, a transform function to discard a value less than or equal to a decimal point from data of a specific column, or a transform function to align the data of a specific column.

The input data of a machine learning model trained based on the first training data may be generated based on the at least one first transform function included in the stored first metadata, and the input data of a machine learning model trained based on the third training data may be generated based on the at least one first transform function and the at least one second transform function included in the stored second metadata.

According to various embodiments as described above, a more convenient environment of developing a machine learning model may be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating data preprocessing according to an embodiment of the disclosure;

FIG. 2 is a block diagram of an electronic apparatus according to an embodiment of the disclosure;

FIG. 3 is a diagram illustrating a training process and an inference process of a model according to an embodiment of the disclosure;

FIG. 4 is a diagram of information stored in a storage according to an embodiment of the disclosure;

FIG. 5A is a diagram of applying a transform function to original data based on a user input according to an embodiment of the disclosure;

FIG. 5B is a diagram of metadata of a transform function applied in FIG. 5A according to an embodiment of the disclosure;

FIG. 5C is a diagram illustrating training data using metadata illustrated in FIG. 5B and applying an additional transform function based on a user input according to an embodiment of the disclosure;

FIG. 6 is a diagram illustrating a process of generating various training data according to an embodiment of the disclosure;

FIG. 7 is a diagram illustrating a process of inferring a model trained according to an embodiment of the disclosure;

FIG. 8A is a diagram illustrating a UI screen provided by a server according to an embodiment of the disclosure;

FIG. 8B is a diagram illustrating a UI screen provided by a server according to an embodiment of the disclosure; and

FIG. 9 is a flowchart of a method for controlling an electronic apparatus according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The suffix “part” for a component used in the following description is given or used in consideration of the ease of writing the specification, and does not have a distinct meaning or role as it is.

The terminology used herein is used to describe embodiments, and is not intended to restrict and/or limit the disclosure. The singular expressions include plural expressions unless the context clearly dictates otherwise.

It is to be understood that the terms such as “comprise” or “have” may, for example, be used to designate a presence of a characteristic, number, operation, element, component, or a combination thereof, and not to preclude a presence or a possibility of adding one or more of other characteristics, numbers, operations, elements, components or a combination thereof.

As used herein, terms such as “first,” and “second,” may identify corresponding components, regardless of order and/or importance, and are used to distinguish a component from another without limiting the components.

If it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the another element.

The terms used in the embodiments of the disclosure may be interpreted to have meanings generally understood to one of ordinary skill in the art unless otherwise defined.

Various embodiments will be described in detail with reference to the attached drawings.

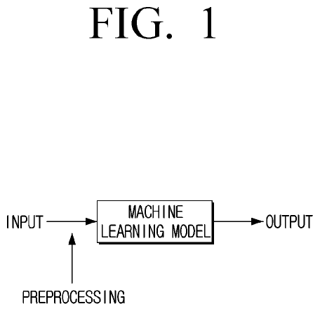

FIG. 1 is a diagram illustrating data preprocessing according to an embodiment of the disclosure.

Referring to FIG. 1, the machine learning model infers (or predicts) output with respect to input.

The data input to the machine learning model should be transformed to be suitable for the algorithm of the model.

For example, if there is missing data among the input data, the machine learning algorithm may not operate properly, so that preprocessing such as removing data or filling the missing data with a specific value is needed. Since the machine learning algorithm prefers learning using numeric data, preprocessing is required to convert text-type data into numeric data. In addition, the input data may be preprocessed according to the algorithm of the model through various methods.

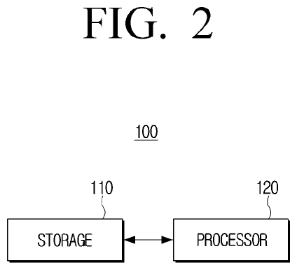

An operation of the electronic apparatus 100, as in FIG. 2, according to the various embodiments is related with preprocessing of data input to a machine learning model.

In particular, the electronic apparatus 100 may store the history of preprocessing of the input data in the storage as metadata in the form of a que, and perform preprocessing on the input data based on the stored metadata, thereby providing a more convenient model development environment to the developer. A specific detail will be described below.

FIG. 2 is a block diagram of an electronic apparatus according to an embodiment of the disclosure.

Referring to FIG. 2, the electronic apparatus 100 includes a storage 110 and a processor 120. According to an embodiment, the electronic apparatus 100 may be a server device.

Although not shown in the drawings, the electronic apparatus 100 may further include a communicator for communicating with various external devices, an input interface (e.g., a keyboard, a mouse, various buttons, etc.) for receiving a user input, and an output interface (e.g., a display or a speaker, etc.) for outputting various information.

Accordingly, the electronic apparatus 100 may transmit and receive various data to and from an external electronic apparatus through a communicator (not shown) according to a user input through an input interface, and may output various data transmitted and received through an output interface.

For example, the electronic apparatus 100 may be provided with a model or original data from an electronic apparatus used by a model developer, and may provide various data (e.g., training data, trained models, metadata, etc.) generated by the operation of the processor 120 to an electronic apparatus used by the model developer. The electronic apparatus 100 may transmit and receive various kinds of data to/from an external electronic apparatus which accesses the electronic apparatus 100 by subscribing to a service provided by the electronic apparatus, but the embodiment is not limited thereto.

The processor 120 may perform preprocessing of the original data by performing transformation of original data based on the transform function.

The transform function refers to various functions defined to transform data to another type, and the meaning of the transform function in the data preprocessing field is obvious to those skilled in the art and thus, a detailed description will be omitted.

The transform function may be input to the processor 120 via a user input. For example, the user may enter the desired transform function through the program executed in the electronic apparatus 100, and the processor 120 may transform the original data based on the input transform function.

According to an embodiment, the transform function may be input to the processor 120 based on the metadata stored in the storage 110. For example, the user may select the metadata stored in the storage 110, and the transform function included in the selected metadata may be automatically applied to the original data.

The processor 120 may generate metadata including the corresponding transform function and store the generated metadata in the storage 110 when the transformation of the original data is performed based on the transform function. The metadata may include a transform function identifier, such as a name of a transform function, order information to which a transform function is applied, a parameter of the applied transform function, or the like.

As described above, according to an embodiment, since the transformation for the original data may be automatically performed by using the transform function obtained through the metadata, the inconvenience of the related-art that a user input is required even when the same transform function is applied may be solved.

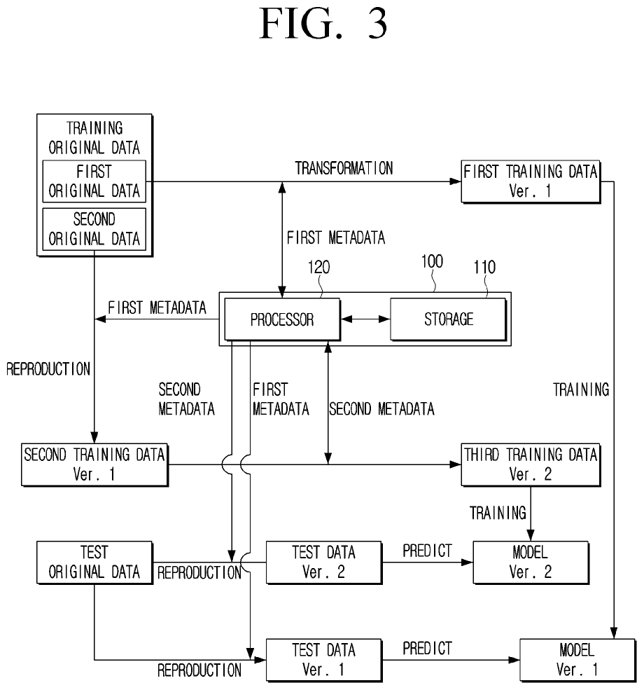

Referring to FIG. 3, the operation of the processor 120 will be further described.

FIG. 3 is a diagram illustrating training and prediction of the model according to an embodiment of the disclosure.

The machine learning model developer may generate training data and train (or learn) the model using the generated training data. At this time, the preprocessing of the data to be input to the model is necessary as described above.

Referring to FIG. 3, the model developer may input at least one first transform function to the electronic apparatus 100 through the user input to generate the training data.

The processor 120 may perform transformation on the first original data based on at least one first transform function input according to a user input to generate first training data, and input the generated first training data into a model to train a model.

The processor 120 may generate first metadata including at least one first transform function used for generating the first training data, and store the generated first metadata in the storage 110.

The model developer may additionally apply at least one first transform function as well as at least one second transform function to the original data to generate other training data, and train the model based on the generated training data.

In the related art, the model developer has to manually input at least one first transform function and at least one second transform function to the electronic apparatus 100, and for this, the model developer has to memorize at least one first transform function previously input.

According to an embodiment, since first metadata including at least one first transform function is stored in the storage 110, the model developer may generate training data to which at least one first transform function is applied by selecting first metadata stored in the storage 110, and additionally input only at least one second transform function through a user input, and may generate other training which has been preprocessed based on at least one first transform function and at least one second transform function.

For example, referring to FIG. 3, the processor 120 may read first metadata stored in the storage 120 according to a user command, and perform transformation for the second original data based on at least one first transform function included in the first metadata.

Hereinafter, transformation of data based on a transform function included in the metadata may be represented as “reproduction” in order to distinguish from transformation based on a transform function input through a user input. When the second original data is reproduced based on the first metadata, the second training data is generated.

The processor 120 may perform transformation on the second training data based on at least one second transform function input according to a user input to generate third training data, and input the generated third training data into a model to train a model.

The processor 120 may generate second metadata including at least one first transform function and at least one second transform function used for generating the third training data, and store the generated second metadata in the storage 110.

The second metadata may be generated by updating information related to at least one second transform function added through the user input to the first metadata, but the embodiment is not limited thereto.

Referring to FIG. 3, first, second, and third are expressions to distinguish data from each other and the version (Ver. 1, Ver. 2) is an expression to distinguish preprocessing performed on the data.

In relation to a version of the training data, the Ver. 1 indicates that the data has been transformed based on at least one first transform function, and the Ver. 2 indicates that the data is transformed based on the at least one first transform function and the at least one second transform function.

With respect to the model, the Ver. 1 indicates that the model is trained using training data generated based on the at least one first transform function, and the Ver. 2 indicates that the model is trained using the training data generated based on the at least one first transform function and the at least one second transform function.

As illustrated in FIG. 3, the training data applied with the same transform function may have the same version even for the different data, and the model also may be divided according to the version of the training data.

The preprocessing of the input data is required even in case of predicting a result by inputting data into the trained model as well as in case of training the model by inputting the generated training data.

The model of Ver. 1 is a model trained by using the training data of Ver. 1 and the input data needs to be transformed by applying the transform function same as the transform function applied to the training data of Ver. 1.

As illustrated in FIG. 3, the test data of Ver. 1 input to the model of Ver. 1 may be generated by applying at least one transform function to the test original data.

The processor 120 may automatically generate test data of the Ver. 1 using at least one first transform function included in the first metadata stored in the storage 110, rather than receiving at least one first transform function through the user input.

The storage 110 may store information in which the trained (or learned) model and the metadata used for the training of a model are matched, and the processor 120 may generate test data of a version corresponding to the model with reference to the matching information.

The above description is the same for the test data input to the model of Ver. 2 and a duplicate description will be omitted.

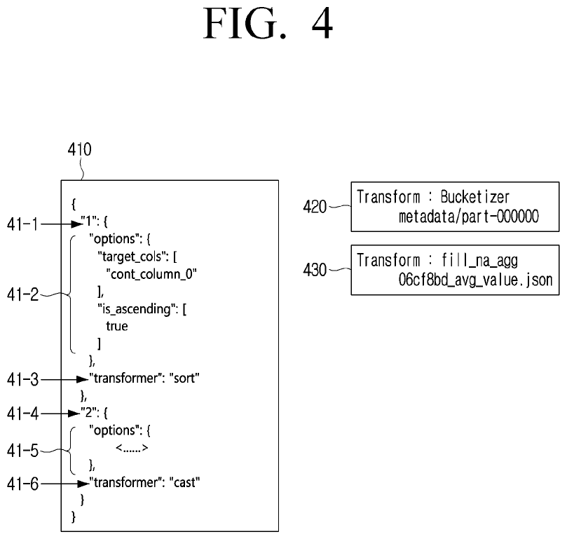

FIG. 4 is a diagram of information stored in a storage according to an embodiment of the disclosure.

Referring to FIG. 4, the storage 110 may store a metadata 410, a related model 420, and a result value 430 applied with the transform function.

The metadata 410 may include information 41-2, 41-3, 41-5, 41-6 about the transform function and order information 41-1 and 41-4 to which the transform function is applied. The information on the transform function may include names 41-3 and 41-6 of the transform function and parameters 41-2 and 41-5 for each transform function.

According to the metadata 410 of FIG. 4, transform function “sort” is applied to original data with the content as the parameter 41-2, and then transform function “cast” is applied to the parameter 41-5 with the same content and preprocessing is performed.

A related model may be stored in the storage 110. The related model refers to various models required for preprocessing of data, rather than a model to be trained as described above. Referring to FIG. 4, a related model 420 for distinguishing data is illustrated as an example,

The result value 430 to which a transform function is applied may be stored in the storage 110. Referring to FIG. 4, the result value 430 to which a transform function filling an average value is applied to a null value of a total column is illustrated.

According to an embodiment, the metadata 410 may be stored in the database of the storage 110, the related model 420, and the result value 430 may be stored in a file system, but the embodiment is not limited thereto.

The storage 110 may further store the original model, training data, trained (or learned model), matching information described above, or the like.

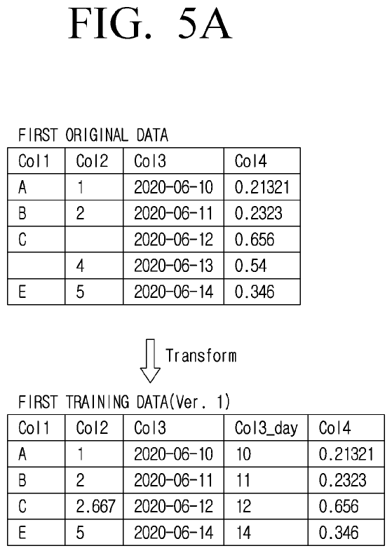

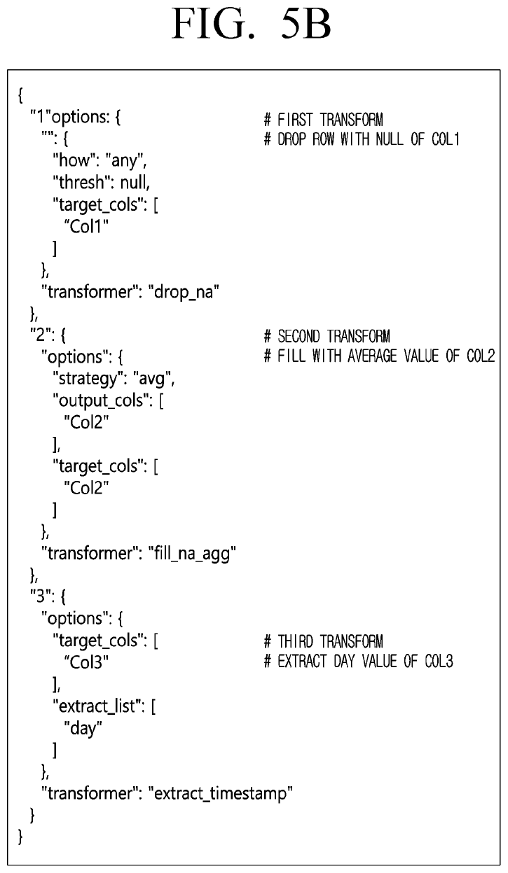

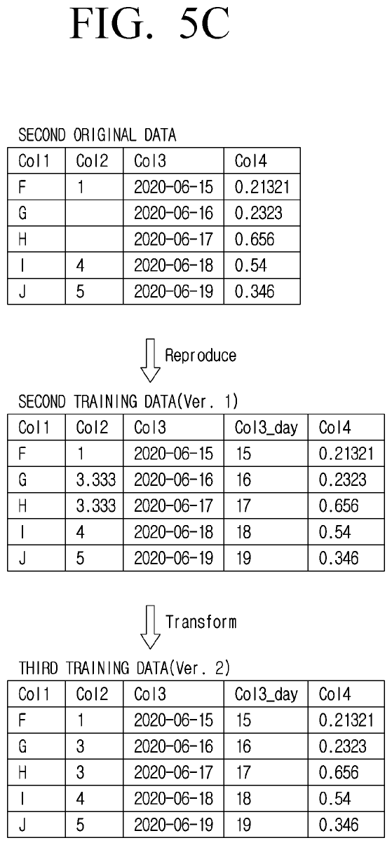

Hereinbelow, a data preprocessing process according to an embodiment will be described in detail with reference to FIGS. 5A to 5C.

The original data and training data shown in FIGS. 5A to 5C are illustrated to correspond to the original data and training data of FIG. 3 for ease of understanding. According to an embodiment, the original data may be a data in a table format including a plurality of columns, and FIGS. 5A to 5C illustrate original data in the format of such tables.

FIG. 5A is a diagram of applying a transform function to original data based on a user input according to an embodiment of the disclosure.

Referring to FIG. 5A, when the first original data and the first training data are compared, a row with a null of the first column Col 1 is deleted, and the null of the second column Col 2 is filled with an average value, and the date value of the third column Col 3 is extracted to generate a new column of Col 3_day, with respect to the first original data.

The model developer may input a transform function to drop the row with the null of Col 1, a transform function to fill the null of Col 2 with an average value of Col 2, and a transform function to extract a day value of Col 3 to the electronic apparatus 100 sequentially, and the processor 120 may generate first training data by transforming the first original data, as shown in FIG. 5A, based on the input transform function.

As described above in FIG. 3, the processor 120 may generate first metadata including first transform functions used for generating the first training data, and store the generated first metadata in the storage 110. FIG. 5B illustrates an example of the first metadata generated by the processor 120.

FIG. 5B is a diagram of metadata of a transform function applied in FIG. 5A according to an embodiment of the disclosure.

FIG. 5C is a diagram illustrating training data using metadata referring to FIG. 5B and applying an additional transform function based on a user input according to an embodiment of the disclosure.

The model developer may wish to perform data preprocessing by adding the transform function to remove a number below or equal to a decimal point of Col 2 in addition to a transform function to drop the row with the null of Col 1, a transform function to fill the null of Col 2 with an average value of Col 2, and a transform function to extract a day value of Col 3.

Referring to FIG. 5B, the processor 120 may perform a transform on the second original data based on first transform functions included in the first metadata according to a user command to generate second training data. The processor 120 may generate third training data by performing a transformation on the second training data based on a transform function for discarding the number equal to or below a decimal point of Col 2 input according to the user input.

According to an embodiment, the processor 120 may identify whether the shape of the second original data is the same as the shape of the first original data, and may perform transformation on the second original data based on transform functions included in the first metadata when the shape of the first original data is the same.

When the number and name of the plurality of columns included in the first and second original data are the same with each other and the type of the data included in the same column is the same with each other, the processor 120 may identify that the format of the second original data is the same as the format of the first original data, and may perform the transformation of the second original data based on the first transform functions included in the first metadata.

Referring to the example of FIG. 5C, the number of columns of the second original data, which are 4, is equal to the number of columns of the first original data, the names of the respective columns are the same as Col 1 to Col 4, and the formats of data included in each column are the same, so that the processor 120 may identify that the second original data and the first original data have identical formats.

The processor 120 may sequentially apply, to the second original data, a transform function to drop a null row of Col 1, a transform function to fill the null of Col 2 with an average value of Col 2, and a transform function to extract a day value of Col 3 to generate second training data.

Referring to the second training data of FIG. 5C, the second original data does not have a row with null in Col 1, and thus there is no dropped row. Since there is a null in the second and third rows of Col 2, the second and third rows of Col 2 are filled with 3.333, which is the average value of Col 2. Also, a day value of Col 3 is extracted and a column of Col 3_day is newly added.

The processor 120 may perform transformation on the second training data based on a transform function that discards the number of points below or equal to the decimal point of the Col 2 input according to the user input, thereby generating third training data. Referring to FIG. 5C, it may be identified that 3.333 of the second and third rows of Col 2 of the second training data are transformed to 3.

The processor 120 may generate second metadata including a transform function that drops a null row of Col 1, a transform function that fills a null of Col 2 with an average value of Col 2, a transform function that extracts a day value of Col 3, a transform function that discards the number below or equal to a decimal point of Col 2, and may store the generated second metadata in the storage 110.

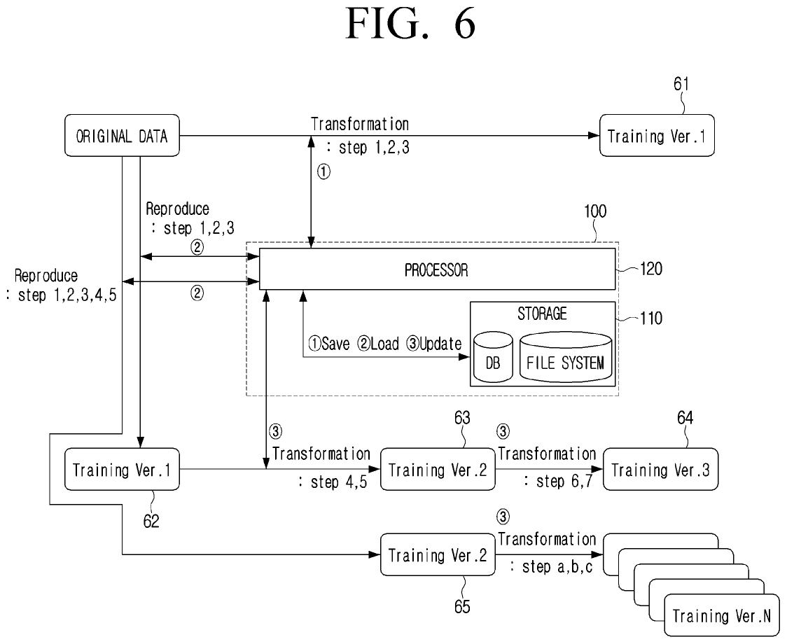

FIG. 6 is a diagram illustrating a process of generating various training data according to an embodiment of the disclosure.

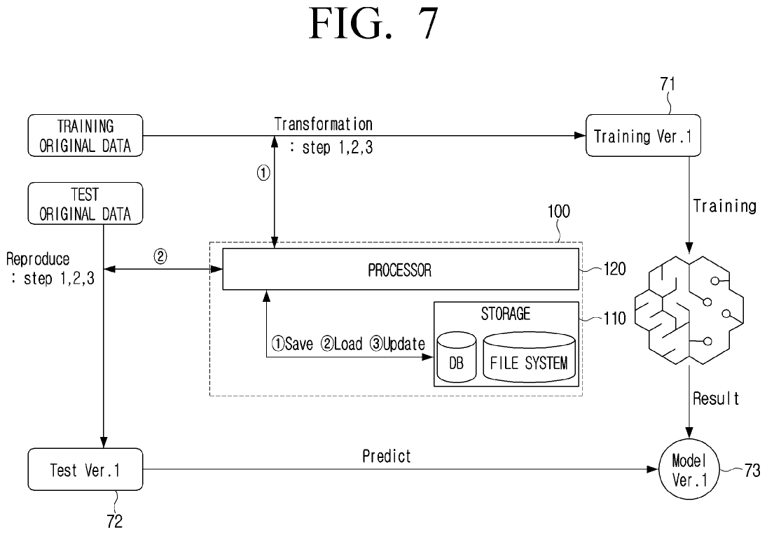

Referring to FIG. 6, only versions of the training data are differently displayed. Referring to FIGS. 6 and 7, \textcircled{1} represents an operation of storing the metadata in the storage 110 by the processor 120, \textcircled{2} represents an operation of loading metadata in the storage 120 by the processor 120, and \textcircled{3} represents an operation of storing (or updating) the metadata in the storage 110 by the processor 120, respectively.

Referring to FIG. 6, the processor 120 may generate the training data Ver. 1 61 by sequentially applying the transform functions 1, 2, 3 input according to the user input to the original data.

The processor 120 may generate the first metadata for transform functions 1, 2, 3 which are used to generate the training data Ver. 1 61 and store the first metadata in the storage 110.

In order to make training data Ver. 2 63 in which transform functions 1, 2, 3, 4, and 5 are sequentially applied, in the related art, a user needs to sequentially input the transform functions 1, 2, 3, 4, 5 manually.

However, according to various embodiments, as shown in FIG. 6, the user may easily reproduce the training data Ver.1 62 using the first metadata, and then input only the transform functions 4 and 5 to the electronic apparatus 100 to easily make the training data Ver. 2 63.

The processor 120 may load the first metadata from the storage 110 according to a user command and may reproduce the training data Ver. 1 62 based on the transform functions 1, 2, 3 included in the loaded first metadata.

The processor 120 may generate training data Ver. 2 63 by applying transform functions 4, 5 input through the user input to training data Ver. 1 62.

The processor 120 may generate the second metadata for transform functions 1, 2, 3, 4, 5 used for generating training data Ver. 2 63 and store (or update) the second metadata in the storage 110.

In accordance with cases, the user may make the training data Ver. 2 63 and then may additionally input the transform functions 6, 7 to the electronic apparatus 100, thereby making the training data Ver.3 64. In this case, the metadata including the transform functions 1, 2, 3, 4, 5, 6, and 7 is stored (or updated) in the storage 110.

The user may additionally apply a transform function a or b or c to the transform functions 1, 2, 3, 4, and 5 to make each version of the training data. In this case, the user may easily reproduce the training data Ver. 2 65 using the second metadata and input the transform function a or b or c into the electronic apparatus, thereby easily making the training data of various versions as shown in FIG. 6. In this case, metadata including transform functions used to generate each training data is stored (or updated) in storage 110, respectively.

FIG. 7 is a diagram illustrating a process of inferring (or predicting) a model trained according to an embodiment of the disclosure.

Referring to FIG. 7, the processor 120 may sequentially apply the transform functions 1, 2, and 3 inputted according to the user input to the training original data to generate the training data Ver. 1 71. The processor 120 may generate metadata for the transform functions 1, 2, and 3 used to generate the training data Ver. 1 71 and store the metadata in the storage 110.

The training data Ver. 1 71 generated as above may be used for training (or learning) of the model. FIG. 7 illustrates that a model is trained through training data Ver. 1 71 to generate a model Ver. 1 73. The processor 120 may store matching information in which the model Ver. 1 73 is matched with the metadata (metadata about transform functions used for generating the training data Ver. 1 71 in the storage 110.

Afterwards, when inputting test data to evaluate the performance of the model Ver. 1 73, the metadata stored in the storage 110 may be used.

The processor 120 may identify that metadata for the transform functions 1, 2, and 3 is required for preprocessing of the test original data with reference to the matching information stored in the storage 110.

The processor 120 may transform the test original data based on the transform functions 1, 2, and 3 included in the metadata, and may automatically generate the test data Ver. 1 72.

The processor 120 may input test data Ver. 1 72 to the model Ver. 1 73 to predict a result.

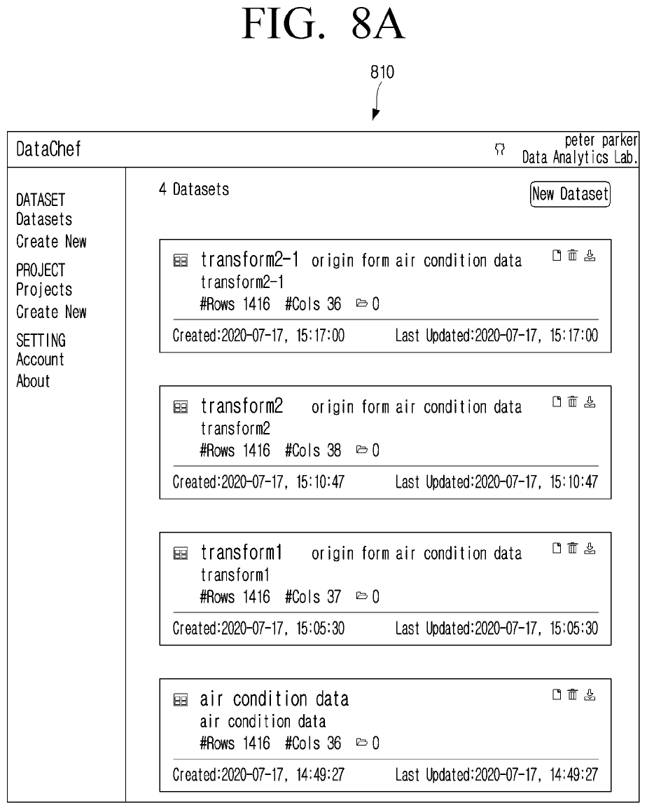

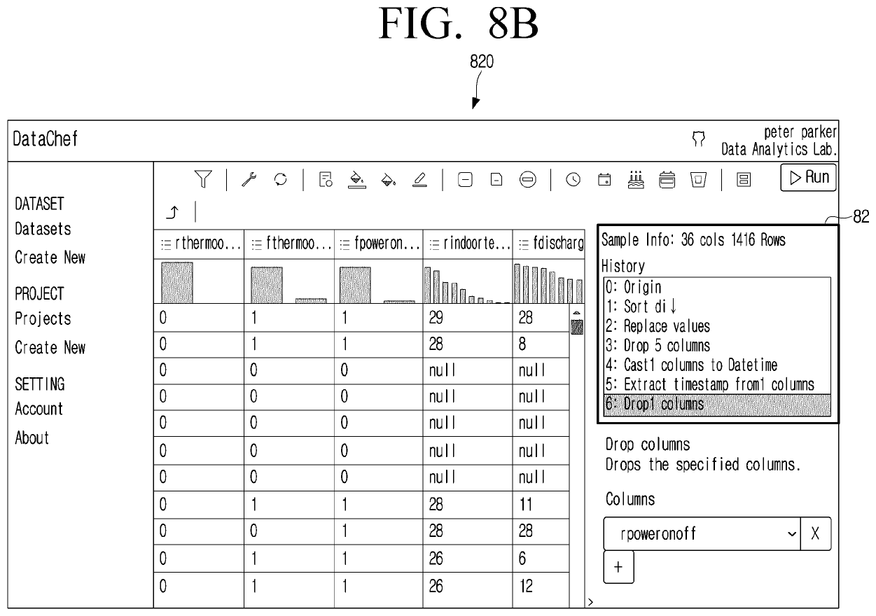

FIGS. 8A and 8B illustrate a UI screen provided by a server according to various embodiments of the disclosure.

Referring to FIGS. 8A and 8B, according to various embodiments, since the history of performing the preprocessing is stored in the storage 110 as metadata in the form of a queue, various UI screens may be provided by using the stored information, thereby providing a more convenient model development environment to the developer.

For example, the various training data generated as described above may be stored in the storage 110 for each version according to the performed preprocessing. Accordingly, as shown in 810 of FIG. 8A, a UI screen capable of identifying the training data for each version may be provided.

As described above, since the metadata regarding the transform function used for generating the training data is stored in the storage 110, a UI screen capable of managing or editing the transformation history for the training data, such as 820 in FIG. 8B, may be provided using the metadata.

Reference numeral 82 of FIG. 8B shows history of transform functions applied to one training data. The user may redo or undo the transform function included in the history, and may perform various preprocessing.

The UI screens 810 and 820 shown in FIGS. 8A and 8B are merely one example, but the UI screen that may be provided using the preprocessing history stored in the storage 110 is not limited thereto, and various UI screens for providing a convenient development environment to the model developer may be provided based on the various information described above, which may be stored in the storage 110.

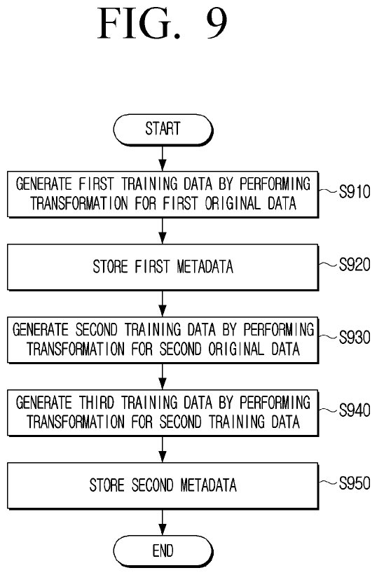

FIG. 9 is a flowchart of a method of controlling an electronic apparatus according to an embodiment of the disclosure. According to various embodiments, each of the first and second original data may be a table type data including a plurality of columns.

Referring to FIG. 9, the electronic apparatus 100 may generate first training data by performing transformation for first original data based on at least one first transform function input according to a user input in operation S910.

The electronic apparatus 100 may generate first metadata including at least one first transform function and store the generated first metadata in the storage 100 in operation S920.

For example, the electronic apparatus 100 may store, in the storage 110, the first metadata including a plurality of first transform functions applied to the first original data and sequence information in which the plurality of first transform functions are applied.

The electronic apparatus 100 may perform transformation on the second original data based on at least one first transform function included in the first metadata stored in the storage 110 to generate second training data in operation S930.

For example, the electronic apparatus 100 may perform transformation for the second original data by applying the plurality of first transform functions to the second original data based on the sequence information included in the stored first metadata stored in the storage 100.

According to an embodiment, the electronic apparatus 100 may, based on a number and a name of a plurality of columns included in the first original data and the second original data being identical with each other, and formats of data included in the same column being identical with each other, perform transformation for the second original data based on at least one first transform function included in the stored first metadata.

The electronic apparatus 100 may generate third training data by performing transformation for the second training data generated in S930 based on at least one second transform function input according to a user input in operation S940.

The electronic apparatus 100 may store second metadata including the at least one first transform function and the at least one second transform function in the storage 110 in operation S950. For example, the electronic apparatus 100 may store, in the storage 110, the first metadata including a plurality of first transform functions applied to the first original data and sequence information in which the plurality of first transform functions are applied.

According to an embodiment, each of the first transform function and the second transform function may include at least one of a transform function to delete a specific row from the data in the table format, a transform function to fill a null value of a specific column, a transform function to extract a specific value from data of a specific column, a transform function to discard a value less than or equal to a decimal point from data of a specific column, or a transform function to align the data of a specific column.

According to an embodiment, the input data of a machine learning model trained based on the first training data may be generated based on the at least one first transform function included in the stored first metadata, and input data of a machine learning model trained based on the third training data may be generated based on the at least one first transform function and the at least one second transform function included in the stored second metadata.

According to various embodiments of the disclosure as described above, an environment of developing a machine learning model which is more convenient may be provided.

The various embodiments described above may be implemented as software including instructions stored in a machine-readable storage media which is readable by a machine (e.g., a computer). The device may include the electronic apparatus 100 according to the disclosed embodiments, as a device which calls the stored instructions from the storage media and which is operable according to the called instructions.

When the instructions are executed by a processor, the processor may directory perform functions corresponding to the instructions using other components or the functions may be performed under a control of the processor. The instructions may include code generated or executed by a compiler or an interpreter. The machine-readable storage media may be provided in a form of a non-transitory storage media. The ‘non-transitory’ means that the storage media does not include a signal and is tangible, but does not distinguish whether data is stored semi-permanently or temporarily in the storage media.

According to an embodiment of the disclosure, the method according to the various embodiments described herein may be provided while being included in a computer program product. The computer program product can be traded between a seller and a purchaser as a commodity. The computer program product may be distributed in the form of a machine-readable storage medium (e.g.: a compact disc read only memory (CD-ROM)), or distributed online through an application store (e.g.: PLAYSTORE™). In the case of online distribution, at least a portion of the computer program product may be at least temporarily stored in a storage medium such as a server of a manufacturer, a server of an application store, or a memory of a relay server, or temporarily generated.

Further, each of the components (e.g., modules or programs) according to the various embodiments described above may be composed of a single entity or a plurality of entities, and some subcomponents of the above-mentioned subcomponents may be omitted or the other subcomponents may be further included to the various embodiments. Generally, or additionally, some components (e.g., modules or programs) may be integrated into a single entity to perform the same or similar functions performed by each respective component prior to integration. Operations performed by a module, a program, or other component, according to various embodiments, may be sequential, parallel, or both, executed iteratively or heuristically, or at least some operations may be performed in a different order, omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a storage; and
a processor configured to:
generate first training data by performing transformation for first original data based on at least one first transform function input according to a user input, store first metadata including the at least one first transform function in the storage,
generate second training data by performing transformation for second original data based on at least one first transform function included in the stored first metadata,
generate third training data by performing transformation for the second training data based on at least one second transform function input according to another user input, and
store second metadata including the at least one first transform function and the at least one second transform function in the storage.

2. The electronic apparatus of claim 1, wherein the processor is further configured to:
store, in the storage, the first metadata including a plurality of first transform functions applied to the first original data and sequence information where the plurality of first transform functions are applied, and
perform transformation for the second original data by applying the plurality of first transform functions to the second original data based on the sequence information included in the stored first metadata.

3. The electronic apparatus of claim 2, wherein the processor is further configured to store, in the storage, the second metadata including the plurality of first transform functions, the at least one second transform function applied to the second training data, and the sequence information where the plurality of first and second transform functions are applied with reference to the second original data.

4. The electronic apparatus of claim 1, wherein the first original data and the second original data, respectively, are data in a table format including a plurality of columns.

5. The electronic apparatus of claim 4, wherein the processor is further configured to, based on a number and a name of a plurality of columns included in the first original data and the second original data being identical with each other, and formats of data included in the same column being identical with each other, perform transformation for the second original data based on at least one first transform function included in the stored first metadata.

6. The electronic apparatus of claim 4, wherein each of the first transform function and the second transform function comprises at least one of a transform function to delete a specific row from the data in the table format, a transform function to fill a null value of a specific column, a transform function to extract a specific value from data of a specific column, a transform function to discard a value less than or equal to a decimal point from data of a specific column, or a transform function to align the data of a specific column.

7. The electronic apparatus of claim 1,
wherein input data of a machine learning model trained based on the first training data is generated based on the at least one first transform function included in the stored first metadata, and
wherein input data of a machine learning model trained based on the third training data is generated based on the at least one first transform function and the at least one second transform function included in the stored second metadata.

8. A method for controlling an electronic apparatus, the method comprising:
generating first training data by performing transformation for first original data based on at least one first transform function input according to a user input;
storing first metadata including the at least one first transform function in a storage;
generating second training data by performing transformation for second original data based on at least one first transform function included in the stored first metadata;
generating third training data by performing transformation for the second training data based on at least one second transform function input according to another user input; and
storing second metadata including the at least one first transform function and the at least one second transform function in the storage.

9. The method of claim 8,
wherein the storing the first metadata in the storage comprises storing, in the storage, the first metadata including a plurality of first transform functions applied to the first original data and sequence information in which the plurality of first transform functions are applied, and
wherein the generating of the second training data comprises performing transformation for the second original data by applying the plurality of first transform functions to the second original data based on the sequence information included in the stored first metadata.

10. The method of claim 9, wherein the storing of the second metadata in the storage comprises storing, in the storage, the second metadata including the plurality of first transform functions, the at least one second transform function applied to the second training data, the sequence information in which the plurality of first and second transform functions are applied with reference to the second original data.

11. The method of claim 8, wherein the first original data and the second original data, respectively, are data in a table format including a plurality of columns.

12. The method of claim 11, wherein the generating of the second training data comprises, based on a number and a name of a plurality of columns included in the first original data and the second original data being identical with each other, and formats of data included in the same column being identical with each other, performing transformation for the second original data based on at least one first transform function included in the stored first metadata.

13. The method of claim 11, wherein each of the at least one first transform function and the at least one second transform function comprises at least one of a transform function to delete a specific row from the data in the table format, a transform function to fill a null value of a specific column, a transform function to extract a specific value from data of a specific column, a transform function to discard a value less than or equal to a decimal point from data of a specific column, or a transform function to align the data of a specific column.

14. The method of claim 8,
wherein input data of a machine learning model trained based on the first training data is generated based on the at least one first transform function included in the stored first metadata, and
wherein input data of a machine learning model trained based on the third training data is generated based on the at least one first transform function and the at least one second transform function included in the stored second metadata.
